(19) United States
(12) Patent Application Publication
(10) Pub. No.: US 2024/0371404 A1
(43) Pub. Date: Nov. 7, 2024

(54) SUBSTRATE FOR MAGNETIC DISK, MANUFACTURING METHOD THEREOF, AND MAGNETIC DISK

(71) Applicants: FURUKAWA ELECTRIC CO., LTD., Tokyo (JP); UACJ Corporation, Tokyo (JP)

(72) Inventors: Hideyuki HATAKEYAMA, Tokyo (JP); Koichiro TAKIGUCHI, Tokyo (JP)

(21) Appl. No.: 18/686,441

(22) PCT Filed: Aug. 25, 2022
(86) PCT No.: PCT/JP2022/032023

§ 371 Date: Feb. 26, 2024

(30) Foreign Application Priority Data
Aug. 26, 2021 (JP) 2021-137920

(51) Int. Cl. G11B 5/73; G11B 5/82; G11B 5/84

(52) U.S. Cl. CPC G11B 5/73; G11B 5/82; G11B 5/8404

(57) ABSTRACT

The purposes of the present invention are to provide a substrate for a magnetic disk and a disk capable of maintaining long-term reliability of a hard disk while dealing with an increase in capacity of the hard disk and to provide a manufacturing method by which a magnetic disk (substrate therefor) having the above-mentioned characteristic can be manufactured. The present invention pertains to: a magnetic disk (substrate therefor) having a pair of main surfaces, wherein a 0.4 to 5.0 mm cutoff wavelength of at least one of the main surfaces of the magnetic disk (substrate therefor) at 25° C. after a predetermined thermal shock test has long wavelength waviness Wa of 2.0 nm or less, especially 0.5 to 2.0 nm, and a 0.08 to 0.45 mm cutoff wavelength thereof has short wavelength waviness μWa of 0.15 nm or less, especially 0.05 to 0.15 nm; and a manufacturing method thereof.

### TECHNICAL FIELD

The present invention relates to a substrate for a magnetic disk, and a manufacturing method thereof, and a magnetic disk.

### BACKGROUND ART

In recent years, due to rapid spread of cloud computing, hard disks (including hard disk devices, such as hard disk drives) for use in data centers are required to have increased capacities. Specifically, enhancement of hard disk capacity can be achieved by increasing the number of stacked magnetic disk substrates through reduction in thickness or by increasing the diameter of each substrate for a magnetic disk and the like. However, the sizes of housings for hard disks are standardized and accordingly, it is difficult to increase the diameter of each substrate for a magnetic disk to be stored therein.

Consequently, reduction in thickness of each substrate for a magnetic disk has been strongly demanded.

Typically, magnetic disks attached (equipped) in hard disks are each formed by providing a magnetic layer or the like on a main surface of a disk-shaped substrate for a magnetic disk. Various types have been proposed as such substrates for each magnetic disk. For example, Patent Document 1 discloses a magnetic disk glass substrate for constituting a magnetic disk with a plate thickness of 0.8 mm or the like where the variation in flatness and the surface waviness in a disk blank state before a fine polishing process are set within prescribed ranges.

### CITATION LIST

### Patent Document

Patent Document 1: Japanese Patent No. 6259022

### DISCLOSURE OF THE INVENTION

### Problems to be Solved by the Invention

Some techniques for reducing failures, such as a head crash and a thermal asperity failure, in a hard disk have been disclosed so far.

For example, for the sake of preventing a thermal asperity failure, the waviness and asperity of a substrate for a magnetic disk have been discussed (e.g., Patent Document 1). However, the conventional discussion about the waviness and asperity of a substrate for a magnetic disk focuses on the waviness and/or asperity in a stage before use as a magnetic disk, such as a stage before a fine polishing process for a substrate for a magnetic disk or after the fine polishing process. No discussion focusing on a long-wavelength waviness Wa and a short-wavelength waviness μWa after a thermal shock test performed as an accelerated test simulating an actual use environment has been made.

Meanwhile, as described above, as the hard disk capacity has been enhanced, increase in the number of stacked magnetic disks, i.e., reduction in thickness of each of substrate for a magnetic disks constituting the magnetic disk has been advanced, but in particular, in comparison with a substrate for a magnetic disk with a thickness of 0.5 mm or more, a substrate for a magnetic disk with a thickness less than 0.5 mm sometimes has a large substrate waviness, which is a factor of reducing the tracking capability of a magnetic head, after each substrate is implemented as a magnetic disk in a hard disk, and the hard disk is used (driven) for a long time period, such as 1,000 to 1,500 thousand hours. In case the substrate for a magnetic disk has an increased waviness, the magnetic head, arranged with a predetermined clearance (e.g., 10 nm) on a main surface of the magnetic disk, is degraded in its tracking ability with respect to a main surface of the substrate for a magnetic disk, which resultantly prevents desired reading and writing in long-term driving of the hard disk, and reduces the reliability (long-term reliability).

The present invention has an object to provide a substrate for a magnetic disk and a magnetic disk that can maintain the long-term reliability of the hard disk while allowing the capacity of the hard disk to be increased (increase in the number of stacked disks). The present invention also has an object to provide a manufacturing method that can manufacture the substrate for a magnetic disk having the characteristics described above.

### Means for Solving the Problems

The present inventors have diligently speculated and discussed the long-term reliability of the hard disk having an enhanced capacity, and resultantly found that a surface waviness occurring on a main surface of a substrate for a magnetic disk (or a magnetic disk) having, for example, a reduced thickness less than 0.5 mm after a prescribed thermal shock test assuming an actual use environment is a factor of reducing the long-term reliability of the hard disk.

The discussion has further been advanced based on this knowledge, and it has been found that by setting the long-wavelength waviness Wa with a cutoff wavelength of 0.4 to 5.0 mm measured at 25° C. on one main surface of the substrate for a magnetic disk to 2.0 nm or less, e.g., 0.5 to 2.0 nm, and the short-wavelength waviness μWa with a cutoff wavelength of 0.08 to 0.45 mm to 0.15 nm or less, e.g., 0.05 to 0.15 nm after a thermal shock test, which is performed by (continuously) repeating a cycle of heating a substrate for a magnetic disk as a component at 120° C. for 30 minutes, and subsequently cooling the substrate at −40° C. for 30 minutes 200 times, it is possible to achieve long-term reliability even in a case of using a substrate for a magnetic disk having, e.g., a reduced thickness less than 0.5 mm, which is equivalent to or better than in a case of using a substrate for a magnetic disk with, e.g., a thickness of 0.5 mm or more. Further exhaustive discussion based on such knowledge has led to completion of the present invention.

In other words, the object of the present invention is achieved by the following measures.
[1] A substrate for a magnetic disk having a pair of main surfaces and having
   a long-wavelength waviness Wa of 2.0 nm or less with a cutoff wavelength of 0.4 to 5.0 mm and a short-wavelength waviness μWa of 0.15 nm or less with a cutoff wavelength of 0.08 to 0.45 mm, measured at 25° C. on at least one of the main surfaces after the following thermal shock test,
<thermal shock test>
   the thermal shock test being performed by repeating a cycle of heating the substrate for a magnetic disk at 120° C. for 30 minutes and subsequently cooling the substrate for a magnetic disk at −40° C. for 30 minutes for 200 times.
[2] The substrate for a magnetic disk according to [1], having the long-wavelength waviness Wa of 0.5 nm or more, and the short-wavelength waviness μWa of 0.05 nm or more.
[3] The substrate for a magnetic disk according to [1] or [2], wherein the substrate for a magnetic disk has a plate thickness of less than 0.50 mm.
[4] The substrate for a magnetic disk according to any one of [1] to [3], wherein the substrate for a magnetic disk is a disk body having an outer diameter of 95 mm or more.
[5] The substrate for a magnetic disk according to any one of [1] to [4], wherein the substrate for a magnetic disk is for heat-assisted magnetic recording (HAMR) or microwave assisted magnetic recording (MAMR).
[6] A magnetic disk having a pair of main surfaces and having
   a long-wavelength waviness Wa of 2.0 nm or less with a cutoff wavelength of 0.4 to 5.0 mm and a short-wavelength waviness μWa of 0.15 nm or less with a cutoff wavelength of 0.08 to 0.45 mm, measured at 25° C. on at least one of the main surfaces after the following thermal shock test,
<thermal shock test>
   the thermal shock test being performed by repeating a cycle of heating the magnetic disk at 120° C. for 30 minutes and subsequently cooling the magnetic disk at −40° C. for 30 minutes for 200 times.
[7] A manufacturing method of the substrate for a magnetic disk according to any one of [1] to [5], wherein the substrate for a magnetic disk is obtained from a disk blank, the method including:
   a rough polishing step of simultaneously roughly polishing both the main surfaces of the disk blank; and a fine polishing step of finely polishing both the main surfaces of the disk blank subjected to the rough polishing,
   wherein the rough polishing step further includes flipping front and back surfaces of the disk blank in the rough polishing step.
[8] The manufacturing method according to [7] for manufacturing the substrate for a magnetic disk, further including dummy polishing step as a previous step to the rough polishing step, wherein the dummy polishing step is performed using two polishing pads to be used in the rough polishing step and a dummy substrate manufactured under the same conditions as those for the disk blank to adjust a surface state of the polishing pads, and the dummy substrate is polished using the two polishing pads under the conditions similar to the conditions for the rough polishing step until the dummy substrate comes to have a long-wavelength waviness Wa of less than 2.5 nm with a cutoff wavelength of 0.4 to 5.0 mm on one surface, and
   the disk blank is polished in the rough polishing step using the polishing pads with the surface state being adjusted.

In this Description, a numerical range indicated using “to” means a range extending with numerical values described before and after “to” respectively as the lower limit and the upper limit.

### Effects of the Invention

When the substrate for a magnetic disk according to the present invention is provided with a magnetic layer on each main surface and implemented, as a magnetic disk, in a hard disk, the magnetic disk can maintain the long-term reliability of the hard disk while allowing enhancement of capacity of the hard disk to be achieved. The magnetic disk of the present invention exerts similar advantageous effects. According to the method for manufacturing a substrate for a magnetic disk of the present invention, a substrate for a magnetic disk and a magnetic disk that have characteristics described above can be manufactured.

### BRIEF DESCRIPTION OF THE DRAWINGS

FIG. 1 is a flowchart showing an example of an aluminum alloy substrate for a magnetic disk, and a magnetic disk manufacturing method using the same;

FIG. 2 is a flowchart showing an example of a glass substrate for a magnetic disk, and a magnetic disk manufacturing method using the same; and

FIG. 3 schematically shows measurement sites of short-wavelength waviness in Examples.

### PREFERRED MODE FOR CARRYING OUT THE INVENTION

### {Substrate for Magnetic Disk}

A substrate for a magnetic disk is a substrate used for manufacturing a magnetic disk. The material and the shape thereof are not specifically limited. The substrate may be plate-shaped one, disk-shaped or annular one, e.g., a disk body, obtained from a plate-shaped one. The substrate for a magnetic disk has a pair of opposite main surfaces.

The substrate for a magnetic disk according to the present invention has a long-wavelength waviness Wa of 2.0 nm or less, e.g., 0.5 to 2.0 nm, with a cutoff wavelength of 0.4 to 5.0 mm and a short-wavelength waviness μWa of 0.15 nm or less, e.g., 0.05 to 0.15 nm, with a cutoff wavelength of 0.08 to 0.45 mm, measured at 25° C. on at least one of the main surfaces after the thermal shock test described below. In other words, the substrate for a magnetic disk according to the present invention encompasses an aspect where one of the main surfaces (typically, a main surface to which a magnetic head is oppositely arranged) satisfies the long-wavelength waviness Wa and the short-wavelength waviness μWa after the thermal shock test described above, and an aspect where the two main surfaces satisfy the long-wavelength waviness Wa and the short-wavelength waviness μWa after the thermal shock test.

### <Thermal Shock Test>

The thermal shock test is performed by repeating a cycle of heating the substrate for a magnetic disk at 120° C. for 30 minutes and subsequently cooling the substrate for a magnetic disk at −40° C. for 30 minutes for 200 times.

Specifically, the thermal shock test described above can be performed according to any of methods described in Examples. The thermal shock test is performed using a substrate for a magnetic disk on which no magnetic material layer is formed. Typically, a magnetic material layer is formed as a thin film that is thinner than a magnetic disk and accordingly, the variation in thickness thereof substantially has no adverse effect on the long-wavelength waviness and the short-wavelength waviness.

The thermal shock test described above assumes a thermal shock harsher than an actual use environment of a hard disk. By evaluating the surface waviness after the test, the durability of a substrate for a magnetic disk (and a magnetic disk) against a rapid change in actual environmental temperature when implemented in a hard disk can be evaluated. If the long-wavelength waviness Wa with a cutoff wavelength of 0.4 to 5.0 mm is in a range of 2.0 nm or less, e.g., 0.5 to 2.0 nm, and the short-wavelength waviness μWa with a cutoff wavelength of 0.08 to 0.45 mm is in a range of 0.15 nm or less, e.g., 0.05 to 0.15 nm, it is conceivable that the tracking ability of a magnetic head with respect to a main surface of the substrate for a magnetic disk tends not to be degraded even after the substrate is implemented in the hard disk and used for 1,000 to 1,500 thousand hours in an ordinary use environment. In other words, it is conceivable that even in long-term use, scanning can be performed without interference between the main surface and the magnetic head, and data can be read.

As described above, the long-term reliability of the hard disk can be improved.

The “long-wavelength waviness Wa with the cutoff wavelength of 0.4 to 5.0 mm” described above (hereinafter, sometimes simply called “Wa”) is an arithmetic mean waviness of the main surface of the substrate for a magnetic disk measured with the cutoff wavelength ranging from 0.4 to 5.0 mm.

The “short-wavelength waviness μWa with the cutoff wavelength of 0.08 to 0.45 mm” described above (hereinafter, sometimes simply called “μWa”) is an arithmetic mean waviness of the main surface of the substrate for a magnetic disk measured with the cutoff wavelength ranging from 0.08 to 0.45 mm.

The “cutoff wavelength” is a wavelength set in order to exclude components that are not included in the range of the cutoff wavelength from a measured sectional curve when the long-wavelength waviness or the short-wavelength waviness is obtained.

According to the present invention, the Wa and μWa of the main surface of the substrate for a magnetic disk are measured after the thermal shock test described above.

Wa and μWa after the thermal shock test can be measured by each of methods described in Examples.

If Wa after the thermal shock test exceeds 2.0 nm, or μWa after the thermal shock test exceeds 0.15 nm, the magnetic head is sometimes incapable of tracking the magnetic disk surface when the magnetic disk is rotated at high speed. In other words, there is a possibility that when a substrate for a magnetic disk is formed as a magnetic disk, implemented in a hard disk, and used for a long time, such as 1,000 to 1,500 thousand hours, a surface waviness occurs, and the magnetic head is incapable of tracking the magnetic disk surface. Note that it is preferable that Wa after the thermal shock test is less than 0.5 nm and μWa after the thermal shock test is less than 0.05 nm in view of improving the reliability of the hard disk. However, the processing time period can significantly increase and accordingly, in consideration of the cost, it is preferable that Wa is in a range from 0.5 to 2.0 nm and μWa is in a range from 0.05 to 0.15 nm. If both the aforementioned Wa and μWa are in the respective ranges, the surface waviness can be suppressed even when used for a long time, thus allowing the reliability of the hard disk to be improved.

Preferably, the Wa after the thermal shock test is 0.5 to 1.8 nm; more preferably, 0.5 to 1.6 nm.

Preferably, the μWa after the thermal shock test is 0.05 to 0.13 nm; more preferably, 0.05 to 0.11 nm.

In a case of an aluminum alloy substrate described later, Wa after the thermal shock test and μWa after the thermal shock test can be in the respective ranges by execution of DC casting, setting of a press-annealing condition, setting of a polishing condition, etc. In a case of a glass substrate described later, the ranges described above can be achieved by setting the polishing condition.

The plate thickness of the substrate for a magnetic disk may be similar to the plate thickness of an ordinary substrate for a magnetic disk, and can be smaller. Preferably, the plate thickness of the substrate for a magnetic disk is less than 0.50 mm, which can achieve enhancement of hard disk capacity. The lower limit of the plate thickness of the substrate for a magnetic disk is not specifically limited, but is practically 0.30 mm or more.

The outer diameter of the substrate for a magnetic disk may be similar to the outer diameter of an ordinary substrate for a magnetic disk. In a case of using a substrate for a magnetic disk for a 3.5-inch hard disk, it is preferable that the outer diameter of the substrate for a magnetic disk according to the present invention is 95 mm or more. The upper limit is limited by an inside dimension, and is practically 97 mm or less.

The inner diameter of the substrate for a magnetic disk may be similar to the inner diameter of an ordinary substrate for a magnetic disk. In a case of use for a 3.5-inch hard disk, it is preferable that the inner diameter of the substrate for a magnetic disk according to the present invention is 26 mm or less. The lower limit is limited by an outer diameter, and is practically 25 mm or more.

The substrate for a magnetic disk according to the present invention can be used as a magnetic disk by forming a magnetic material layer on at least one of the main surfaces. Preferably, magnetic material layers are formed on both the main surfaces.

The magnetic material layer can be provided in a manner similar to that of an ordinary magnetic disk.

The obtained magnetic disk can be used for, e.g., a nominal 3.5-inch hard disk.

It is known that the thicknesses of dominant 3.5-inch hard disk housings are 20 mm, 26 mm, etc.

In a case where the plate thickness of each magnetic disk is 0.5 mm, the number of magnetic disks implementable in an ordinary housing that is for 3.5-inch hard disk and has a thickness of 26 mm is nine or less. However, by configuring each magnetic disk to have a plate thickness of 0.5 mm or less, 10 or more magnetic disks can be implemented in the hard disk without largely increasing the thickness of the housing from 26 mm.

Typically, a material allowing achievement of a substrate that has favorable mechanical properties and workability, and is excellently resistant to a failure is used as the material of the substrate for a magnetic disk. Specifically, an aluminum alloy, and glass can be used. Hereinafter, a substrate for a magnetic disk manufactured using an aluminum alloy is sometimes called an aluminum alloy substrate, and a substrate for a magnetic disk manufactured using glass is sometimes called a glass substrate.

The substrate for a magnetic disk according to the present invention may be used as a substrate for a magnetic disk for any recording scheme. Preferably, the substrate is used as any of heat-assisted magnetic recording (HAMR) and microwave assisted magnetic recording (MAMR) magnetic disk substrates.

In the case of use as a magnetic disk substrate for HAMR, it is preferable to use a glass substrate, which is excellent in heat resistance.

In the case of use as a magnetic disk substrate for MAMR, any of glass substrates and aluminum substrates can be used.

### <Aluminum Alloy Substrate>

First, an aluminum alloy substrate is described.

Preferably, an aluminum alloy used for an aluminum alloy substrate contains any of elements, such as Mg, Cu, Zn, and Cr, having conventionally been used. The alloy may contain any of elements, such as Fe, Mn, and Ni, which can improve the stiffness.

Any of Al—Mg alloys, Al—Fe—Mn—Ni alloys, and Al—Fe—Mn—Mg—Ni alloys can be used as the aluminum alloy.

The Al—Mg alloy may be, for example, A5086 (containing Mg: 3.5 to 4.5% by mass, Fe: 0.50% by mass or less, Si: 0.40% by mass or less, Mn: 0.20 to 0.7% by mass, Cr: 0.05 to 0.25% by mass, Cu: 0.10% or less by mass, Ti: 0.15% by mass or less, and Zn: 0.25% by mass or less, with the remaining parts consisting of Al, and unavoidable impurities).

A preferable aspect of an aluminum alloy contains Mg: 1.0 to 6.5% by mass, further contains one or two elements or more among Cu: 0.070% or less by mass, Zn: 0.60% or less by mass, Fe: 0.50% or less by mass, Si: 0.50% or less by mass, Cr: 0.20% or less by mass, Mn: 0.50% or less by mass, Zr: 0.20% or less by mass, and Be: 0.0020% or less by mass, with the remaining parts consisting of aluminum, and unavoidable impurities.

Another preferable aspect of an aluminum alloy contains, as a material to improve the stiffness, Fe that is an essential element, and one or two of Mn and Ni that are optional elements, and has a relationship such that the sum of contents of these Fe, Mn, and Ni is 1.00 to 7.00% by mass, and further contains one or two elements or more among Si: 14.0% or less by mass, Zn: 0.7% or less by mass, Cu: 1.0% or less by mass, Mg: 3.5% or less by mass, Cr: 0.30% or less by mass, Zr: 0.20% or less by mass, Be: 0.0015% or less by mass, Sr: 0.1% or less by mass, Na: 0.1% or less by mass, and P: 0.1% or less by mass, with the remaining parts consisting of aluminum, and unavoidable impurities.

Such an aluminum alloy is called Al—Fe—Mn—Ni alloy, or Al—Fe—Mn—Mg—Ni alloy, depending on the contained component.

Each aluminum alloy described above may contain an element other than the elements described above. The elements other than the elements described above can have contents so that for example, each element has a content of 0.1% or less by mass for each element, and the sum of the contents is 0.3% or less by mass.

### <Glass Substrate>

A glass substrate is described.

Glass ceramics, such as amorphous glass and crystallized glass can be used as a material for the glass substrate. Preferably, amorphous glass is used in view of formability, workability, and surface roughness of a product. It is preferable to use, for example, aluminosilicate glass, soda-lime glass, soda-aluminosilicate glass, alumino-borosilicate glass, borosilicate glass or the like.

A preferable aspect of glass used for a substrate for a magnetic disk is glass that contains SiO₂: 55 to 75% as a main component to which Al₂O₃: 0.7 to 25%, Li₂O: 0.01 to 6%, Na₂O: 0.7 to 12%, K₂O: 0 to 8%, MgO: 0 to 7%, CaO: 0 to 10%, ZrO₂: 0 to 10%, and TiO₂: 0 to 1% are added, in particular, glass that contains SiO₂: 60 to 70%, Al₂O₃: 10 to 25%, Li₂O: 1 to 6%, Na₂O: 0.7 to 3%, MgO: 0 to 3%, CaO: 1 to 7%, ZrO₂: 0 to 3%, and TiO₂: 0 to 1%, or glass that further contains B₂O₃: 1 to 7%, and P₂O₅: 0.1 to 3% that are added thereto. Note that for the compositions described above and below, every “%” means “% by mass”.

SiO₂ is a main component forming a framework of glass. In a case where the content is less than 55%, chemical durability can be degraded. In a case where the content exceeds 75%, the melting temperature can become too high. In both the cases, the implementation sometimes becomes unsuitable.

Al₂O₃ is a component for improving the ion-exchange capability and the chemical durability. In a case where the content is less than 0.7%, the advantageous effect described above can be insufficient. In a case where the content exceeds 25%, the solubility and the devitrification resistance can be degraded. In both the cases, the implementation sometimes becomes unsuitable.

Li₂O is a component of allowing ion-exchange with Na ions and chemically strengthening glass, improving the fusibility and formability, and improving the Young's modulus. In a case where the content is less than 0.01%, the ion-exchange capability can be degraded. In a case where the content exceeds 6%, the devitrification resistance and the chemical durability can be degraded. In both the cases, the implementation sometimes becomes unsuitable.

Na₂O is a component of allowing ion-exchange with K ions and chemically strengthening glass, reducing the high-temperature viscosity, improving the fusibility and formability, and improving the devitrification resistance. In a case where the content is less than 0.7%, the devitrification resistance can be degraded. In a case where the content exceeds 12%, the chemical durability and the Knoop hardness number can be degraded. In both the cases, the implementation sometimes becomes unsuitable.

K₂O has improvement effects of reducing the high-temperature viscosity, improving the fusibility, increasing the formability, and improving the devitrification resistance. In a case where the content exceeds 8%, the low-temperature viscosity can decrease, the thermal expansion coefficient can increase, and the shock resistance can be degraded. In this case, the implementation sometimes becomes unsuitable.

MgO and CaO (contained as essential components in soda-lime glass) have advantageous effects of reducing the high-temperature viscosity, improving the solubility and clarity, and formability, and improving the Young's modulus. However, in a case where the content exceeds MgO: 7% or the content exceeds CaO: 10%, the ion-exchange performance can decrease, and the devitrification resistance can be degraded. In both the cases, the implementation sometimes becomes unsuitable.

ZrO₂ has advantageous effects of increasing the Knoop hardness number, and improving the chemical durability and the heat resistance. In a case where the content exceeds 10%, the fusibility can be degraded, and the devitrification resistance can be degraded. In this case, the implementation sometimes becomes unsuitable.

TiO₂ has advantageous effects of reducing the high-temperature viscosity, improving the fusibility, and improving the structure stabilization and the durability. However, in a case where the content exceeds 1%, the ion-exchange performance can be degraded, and the devitrification resistance can be degraded. In this case, the implementation sometimes becomes unsuitable.

Note that the glass may contain not only B₂O₃ (contained, as an essential component, in alumino-borosilicate glass, and borosilicate glass) that reduces the viscosity, and improves the solubility and clarity, SrO and BaO that have advantageous effects of reducing the high-temperature viscosity, improving the solubility, clarity, and formability, and improving the Young's modulus, ZnO that improves the ion-exchange performance, and reducing the high-temperature viscosity without reducing the low-temperature viscosity, SnO₂ that improves the clarity and the ion-exchange performance, Fe₂O₃ as a colorant and the like, but also As₂O₃ and Sb₂O₃ as clarifying agents, and further contain P₂O₅. Oxides, such as La, P, Ce, Sb, Hf, Rb, and Y, may be contained as trace elements. The glass may have a composition that contains SiO₂: 60 to 70%, Al₂O₃: 10 to 25%, Li₂O: 1 to 6%, Na₂O: 0.7 to 3%, MgO: 0 to 3%, CaO: 1 to 7%, ZrO₂: 0 to 3%, TiO₂: 0 to 1%, B₂O₃: 0.1 to 7%, and P₂O₅: 0.1 to 3%.

### {Method for Manufacturing Substrate for a Magnetic Disk}

The method for manufacturing the substrate for a magnetic disk is not specifically limited, only if the method can manufacture the substrate for a magnetic disk where the long-wavelength waviness Wa and the short-wavelength waviness μWa after the thermal shock test described above are in the respective ranges described above. In view of making the long-wavelength waviness Wa and the short-wavelength waviness μWa in the respective ranges described above, for obtaining a substrate for a magnetic disk from a disk blank (disk-shaped blank substrate), it is preferable that the method for manufacturing the substrate for a magnetic disk according to the present invention includes a rough polishing step of simultaneously roughly polishing both the main surfaces of the disk blank, and a fine polishing step of finely polishing both the main surfaces of the disk blank having been roughly polished, and flips the front and back surfaces of the disk blank in the rough polishing step.

More preferably, the method for manufacturing the substrate for a magnetic disk includes a rough polishing step of simultaneously roughly polishing both the main surfaces using a polishing liquid containing polishing abrasive grains with an average particle diameter of 0.1 to 1.0 μm, and hard or soft polishing pads, and a subsequent fine polishing step of finely polishing both the main surfaces (roughly polished main surfaces) using a polishing liquid containing polishing abrasive grains with an average particle diameter of 0.01 to 0.1 μm, and soft polishing pads, and flips the front and back surfaces of the disk blank in the rough polishing step. It is assumed that polishing abrasive grains having a smaller average particle diameter than the polishing abrasive grains used in the rough polishing step are used as those in the fine polishing step. Here, the “hard property” has a hardness (Asker-C) of 85 or higher measured by a measurement method defined by The Society of Rubber Industry, Japan Standard (compliance standard: SRIS0101), and the “soft property” has a hardness ranging from 60 to 80. The average particle diameter (d50) is what is called a median diameter that means a 50% cumulative particle diameter assuming that a particle size distribution is measured by the laser diffraction and scattering method, and the entire volume of particles is 100% in a cumulative distribution.

The details of conditions for the rough polishing step and the fine polishing step can be configured in accordance with the material of the substrate for a magnetic disk to be manufactured. The details of these polishing steps are described in an aluminum alloy substrate for a magnetic disk, and a method for manufacturing a magnetic disk using the same, and a glass substrate for a magnetic disk, and a method for manufacturing a magnetic disk using the same, which are described later. In the method for manufacturing an aluminum alloy substrate for a magnetic disk described later, a polishing process step in step S111 corresponds to the rough polishing step and the fine polishing step described above. In the method for manufacturing a glass substrate for a magnetic disk described later, a rough polishing step in step S204, and a fine polishing step in step S205 respectively correspond to the rough polishing step and the fine polishing step described above.

The rough polishing step can be executed using a commercially available batch-type double-sided simultaneous polisher. The double-sided simultaneous polisher includes: an upper surface plate and a lower surface plate that are made of cast iron; a carrier that holds a plurality of disk blanks between the upper surface plate and the lower surface plate; and hard or soft polishing pads attached to contact surfaces of the upper surface plate and the lower surface plate with the disk blanks, respectively (i.e., the number of polishing pads are twice the number of disk blanks). The double-sided simultaneous polisher holds the disk blanks between the upper surface plate and the lower surface plate by the carrier, and clamps each disk blank at a predetermined processing pressure by the upper surface plate and the lower surface plate. Accordingly, each disk blank is integrally clamped from the top and bottom (parallel with the gravitational force direction) with the polishing pads. Next, while a polishing liquid is being supplied between the polishing pads and the individual disk blanks at a predetermined supply rate, the upper surface plate and the lower surface plate are rotated in different directions from each other. At this time, the carrier also rotates on its own axis by a sun gear. Accordingly, the disk blanks perform planetary motions. Accordingly, each disk blank is slid on the surfaces of the polishing pads, and both the surfaces are simultaneously polished. The polishing pads are porous (having sac-like holes opening on the surface). Consequently, a polishing liquid is supplied between the polishing pads and the disk blanks via the polishing pads.

The fine polishing step can be executed using the double-sided simultaneous polisher described above.

In order to reduce Wa and μWa after the thermal shock test, it is preferable to make the disk blanks uniformly have distortions mainly in the rough polishing step in the polishing process step. Here, “uniformly have distortions” means making the waviness distribution in a uniform state over the entire principal surfaces of each disk blank.

Wa and μWa tend to decrease with increase in the polishing amount. By making the polishing amounts on the front and back surfaces in the rough polishing step match each other as much as possible, the waviness distribution described above can be made uniform over each of the entire principal surfaces. In view of uniformly making distortions, it is preferable to flip the front and back surfaces of each disk blank in the rough polishing step. It is conceivable that by flipping the front and back surfaces of the disk blank, the polishing pads for polishing the respective main surfaces (polishing surfaces) of the disk blank are replaced with each other, and the way of application of the gravitational force is flipped, thus allowing the polishing amounts on the front and back surfaces to be close to each other.

Furthermore, in view of uniformly making distortions, it is preferable to control the surface state of each polishing pad used in the rough polishing step. The control (adjustment) of the surface state of the polishing pad can be performed in a case where in the rough polishing step, it is difficult to make the long-wavelength waviness Wa with a cutoff wavelength of 0.4 to 5.0 less than 2.5 nm. Adjustment of the surface state of the polishing pad can be performed by an ordinary method if the surface state of the polishing pad can be adjusted to make a disk blank before the rough polishing have a long-wavelength waviness Wa with a cutoff wavelength 0.4 to 5.0 mm less than 2.5 nm. For example, the adjustment can be performed by dummy polishing. For example, in a case where each polishing pad to be used in the rough polishing step is brushed, it is preferable to perform dummy polishing before the rough polishing is performed.

The dummy polishing is a polishing process for adjusting the surface state of each polishing pad used in the rough polishing step described above. In this Description, polishing performed to adjust the surface state of each polishing pad is called “dummy polishing”. Polishing that is performed using the polishing pad after the dummy polishing and makes the long-wavelength waviness Wa with a cutoff wavelength 0.4 to 5.0 mm less than 2.0 nm is called “rough polishing”. The dummy polishing can be performed as described below.

In the dummy polishing, it is preferable to use a disk blank in a state before the rough polishing, as a dummy substrate. For example, in a case where the target to be roughly polished is an aluminum alloy substrate, a disk blank in a state after an electroless Ni—P plating treatment described later and before rough polishing can be used as a dummy substrate. In a case where the target to be roughly polished is a glass substrate, a disk blank obtained in step S202 or S203 described later can be used as a dummy substrate. The dummy polishing uses the dummy substrate described above, and is performed until the long-wavelength waviness Wa of each main surface with a cutoff wavelength of 0.4 to 5.0 mm becomes less than 2.5 nm. The dummy polishing can be performed under the condition similar to that in the rough polishing step. The number of polishing times (the number of times of dummy polishing) is not specifically limited, and the polishing can be performed until the aforementioned Wa is achieved.

The surface-state adjusted polishing pads after applying dummy polishing to the dummy substrate, and polishing the substrate until the long-wavelength waviness Wa with a cutoff wavelength of 0.4 to 5.0 mm becomes less than 2.5 nm are used in the rough polishing step, thereby allowing adjustment such that the difference in polishing amounts of the front and back surfaces in the rough polishing step cannot be large. By reducing the difference in polishing amounts, the aforementioned Wa and μWa can be easily achieved.

In view described above, an aspect of a method for manufacturing a substrate for a magnetic disk according to the present invention may be a manufacturing method that includes a dummy polishing step of adjusting the surface states (states of polishing surfaces) of the polishing pads used for the rough polishing step, as a preliminary step prepared for the rough polishing step. Preferably, the dummy polishing step is a step of polishing a dummy substrate manufactured under the same condition as that for the disk blank using two polishing pads to be used in the rough polishing step, under the conditions similar to the conditions for the rough polishing step (the size of polishing abrasive grains, hardness of the polishing pads, polishing time period, polishing surface plate rotational speed, sun gear rotational speed, polishing liquid supply rate, processing pressure, and polishing amount), until the long-wavelength waviness Wa with a cutoff wavelength of 0.4 to 5.0 mm on one surface becomes less than 2.5 nm, and obtaining the polishing pads with the surface state being adjusted. In the case of performing the dummy polishing step, the rough polishing step, in which a disk blank other than the dummy substrate is roughly polished using the surface-state adjusted polishing pads, is performed after the dummy polishing.

Hereinafter, the substrate for a magnetic disk and the method for manufacturing the magnetic disk according to the present invention are described separately into a method for manufacturing an aluminum alloy substrate for a magnetic disk, and a method for manufacturing a glass substrate for a magnetic disk, in a separated manner.

### <Method for Manufacturing Aluminum Alloy Substrate>

Hereinafter, the aluminum alloy substrate for the magnetic disk, and each step among and each process condition for steps for manufacturing the magnetic disk using the substrate are described in detail.

In manufacturing the aluminum alloy substrate for the magnetic disk according to the present invention, it is preferable to use an aluminum alloy material cast by the semi-continuous casting (DC casting) method. By the continuous casting (CC casting) method, the state of distribution of intermetallic compounds in the aluminum alloy becomes non-uniform, distortions nonuniformly remain in a substrate to be manufactured, and thus the waviness becomes large in some cases.

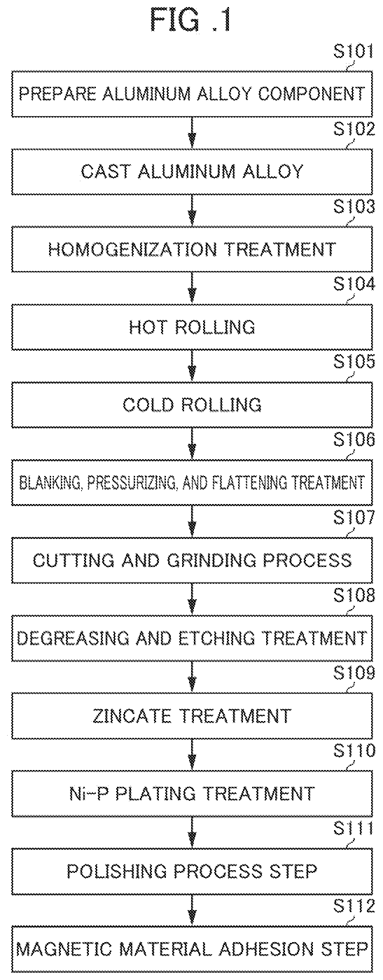

FIG. 1 is a flowchart showing an example of an aluminum alloy substrate, and a magnetic disk manufacturing method using the same. In FIG. 1, an aluminum alloy preparing step (step S101) to cold rolling (step S105) are steps of manufacturing an aluminum alloy material by melt casting, and forming the material into an aluminum alloy plate. Next, by a pressurizing and flattening treatment (step S106), a disk blank made of an aluminum alloy is manufactured. The manufactured disk blank is subjected to a cutting and grinding process step (step S107), and a degreasing and etching treatment (step S108), and a zincate treatment (step S109), an electroless Ni—P plating treatment (step S110), and a polishing process step (step S111), thus manufacturing the aluminum alloy substrate. The manufactured aluminum alloy substrate is formed into a magnetic disk by a magnetic material adhesion step (step S112).

Hereinafter, referring to FIG. 1, the content of each step is described in detail.

First, a molten metal of the aluminum alloy material having the component composition described above is prepared by heating and melting according to a common procedure (step S101).

Next, the prepared molten metal of aluminum alloy material is cast according to, for example, a semi-continuous casting (DC casting) method, thus casting the aluminum alloy material (step S102). In comparison with the case of continuous casting (CC casting), the DC casting can make the state of distribution of intermetallic compounds more uniform. Accordingly, Wa and μWa after the thermal shock test can be within the respective ranges described above. The aluminum alloy material manufacturing conditions and the like in the DC casting method and the CC casting method are not specifically limited, and an ordinary method can be adopted. The DC casting may be the vertical semi-continuous casting method, or the lateral semi-continuous casting method.

According to the DC casting method, the molten metal poured through a spout is deprived of heat by a bottom block, a water-cooled mold wall, and cooling water directly discharged to the periphery of an ingot, set, and drawn below as an aluminum alloy ingot. The ingot obtained in this step is sometimes called a slab.

On the other hand, according to the CC casting method, a casting nozzle is inserted between a pair of rolls (or a belt caster, or a block caster), a molten metal is supplied, and heat is removed from the rolls, thus directly casting an aluminum alloy thin-plate.

The DC casting method and the CC casting method are largely different in the cooling rate in casting. The CC casting method with a higher cooling rate is characterized in that secondary phase particles have a smaller size than in DC casting.

Next, the aluminum ingot obtained by DC casting is hot-rolled, and formed as a plate (step S104). Before the hot rolling, a homogenization treatment (step S103) can be performed as needed. In CC casting, step S105 may be performed subsequent to step S102 without performing these steps.

In step S103, when the homogenization treatment is applied, it is preferable to perform a heating treatment at 280 to 620° C. for 0.5 to 30 hours, and it is more preferable to perform a heating treatment at 300 to 620° C. for 1 to 24 hours. In the temperature range described above, the homogenization is sufficient, which can reduce the variation in loss factor of each aluminum alloy substrate. Furthermore, the aluminum alloy ingot can be prevented from being melt. If the heating time period of the homogenization treatment exceeds 30 hours, the advantageous effect is saturated, and any further significant improvement effect is hard to be achieved.

In step S104 applied to the DC casting method, an aluminum alloy ingot having been subjected to the homogenization treatment or to no homogenization treatment is hot-rolled, and is formed as a plate. The condition for the hot rolling is not specifically limited. However, it is preferable that the hot rolling start temperature ranges from 250 to 600° C., and the hot rolling end temperature ranges from 230 to 450° C.

Next, a hot-rolled sheet, or a cast plate cast by the CC casting method is cold-rolled, and is formed as an aluminum alloy plate with a thickness of about 0.30 to 0.6 mm (step S105). The cold rolling condition is not specifically limited, and may be defined depending on a required product plate strength and plate thickness. Preferably, the rolling ratio ranges from 10 to 95%. An annealing treatment may be applied in order to secure cold rolling workability before the cold rolling or in the cold rolling. In the case of executing the annealing treatment, for example, with batch-type heating, it is preferable that execution is made under the condition at 300 to 450° C. for 0.1 to 10 hours, and with continuous-type heating, it is preferable that execution is made under the condition at 400 to 500° C. being held for 0 to 60 seconds. Here, a holding time of 0 seconds means cooling immediately after a desired holding temperature is reached.

The aluminum alloy plate obtained by cold rolling is annularly formed, and a disk-shaped aluminum alloy plate is obtained. The disk-shaped aluminum alloy plate is formed into a disk blank through the pressurizing and flattening treatment (step S106). A forming process for achieving a disk shape may be performed by punching by a press machine. The pressurizing and flattening treatment applies press-annealing at 250 to 450° C. for 0.5 to 10 hours to the disk-shaped aluminum alloy plate in the atmosphere, while applying a pressure with, for example, a load of 30 to 60 kgf/cm2, thus fabricating a flattened disk blank.

Here, if the temperature of press-annealing is too low, for example, at about 200° C., distortions remain in the material (the distortions cannot be made uniform), and resultantly, Wa and μWa after the thermal shock test cannot be in the respective ranges described above in some cases. Accordingly, for manufacturing the substrate for a magnetic disk according to the present invention, it is preferable to perform press-annealing under the temperature condition at about 250 to 450°, in particular, 300 to 400° C.

The disk blank is subjected to the cutting and grinding process (step S107), and the heating treatment as needed, before the zincate treatment or the like.

The cutting and grinding process applies a cutting process to the inner and outer peripheries of the disk blank, adjusts the shape, and applies a grinding process to the main surfaces. Before this step is performed, a cutting process may be applied to recording surfaces of the disk blank, as a pretreatment for the grinding process. In the process, a chamfering process may be further applied to inner and outer peripheral end faces.

The grinding process can be executed using any of 800s to 4000s SiC grinding stones, and an ordinary batch-type double-sided simultaneous polisher. The double-sided simultaneous polisher includes: an upper surface plate and a lower surface plate that are made of cast iron; a carrier that holds a plurality of aluminum substrates between the upper surface plate and the lower surface plate; and SiC grinding stones attached to contact surfaces with the aluminum substrates of the upper surface plate and the lower surface plate. Depending on a finishing state of the grinding process, Wa varies.

Accordingly, it is preferable to perform finishing with 4000s grinding stones. In the grinding process, the upper and lower surface plates are rotated in the opposite directions, respectively, while each disk blank is held by the carrier. The rotational speeds of the upper and lower surface plates may be 10 to 30 rpm. The carrier is rotated by a sun gear, and accordingly, each disk blank is ground while performing a planetary motion on the grinding stones.

In the case of performing the heating treatment, the heating treatment is performed under the condition that the disk blank is held at 200 to 350° C. for 5 to 60 minutes. By performing the heating treatment, the distortions formed by the cutting and grinding process can be removed, and the distortions can be made uniform.

Furthermore, the degreasing and etching treatment is applied to the disk blank (step S108). The degreasing treatment can be performed by an ordinary method. For example, it is preferable to perform the treatment under the condition at a temperature of 40 to 70° C. for a treatment time period of 3 to 10 minutes using a commercially available degreasing solution or the like.

The etching treatment can be performed by an ordinary method. For example, it is preferable to perform the treatment under the condition at a temperature of 50 to 75° C. for a treatment time period of 0.5 to 5 minutes using a commercially available etching solution or the like.

Next, the zincate treatment (Zn-substitution treatment) is applied to the surface of the disk blank (step S109).

In the zincate treatment, a zincate film is formed on the surface of the disk blank. The zincate treatment can be performed using a commercially available zincate treatment solution. Preferably, the process is performed under the condition at a temperature of 10 to 35° C. for a treatment time period of 0.1 to 5 minutes with a concentration of 100 to 500 mL/L. The zincate treatment is performed at least once, and may be performed twice or more. By performing the zincate treatment multiple times, Zn is finely deposited, and a uniform zincate film can be formed. In a case of performing the zincate treatment twice or more, it is preferable to perform a Zn peeling treatment therebetween. Preferably, the Zn peeling treatment is performed using a nitric acid (HNO₃) solution under the condition at a temperature of 15 to 40° C. for a treatment time period of 10 to 120 seconds with a concentration of 10 to 60%. Preferably, the second and subsequent zincate treatments are executed under the condition similar to that of the first zincate treatment.

Furthermore, the electroless Ni—P treatment (step S110) is applied, as a base treatment for magnetic material adhesion, to the surface of the zincate-treated disk blank. Preferably, in the electroless Ni—P plating treatment step, a plating treatment is performed using a commercially available plating solution or the like under the condition at a temperature of 80 to 95° C. for a treatment time period of 30 to 180 minutes with an Ni concentration of 3 to 10 g/L.

A polishing process is performed on each plated surface after the electroless Ni—P plating treatment (step S111). Preferably, in the polishing process step, polishing in multiple stages is performed with the diameters of the polishing abrasive grains being adjusted. The polishing process step includes at least two stages of polishing that are rough polishing and fine polishing. For example, the rough polishing can be performed so as to roughly polish the main surfaces using a polishing liquid containing alumina with an average particle diameter of 0.1 to 1.0 μm, and hard or soft polishing pads, and subsequently the fine polishing can be performed so as to finely polish the main surfaces using a polishing liquid containing colloidal silica with an average particle diameter about 0.01 to 0.1 μm, and soft polishing pads.

It is difficult to uniquely define other polishing conditions in the rough polishing because effects of the adopted aluminum alloy, treatment conditions in steps S101 to S110 and the like are exerted. However, for example, the polishing time period may be 2 to 5 minutes, the polishing surface plate rotational speed may be 10 to 35 rpm, the sun gear rotational speed may be 5 to 15 rpm, and the polishing liquid supply rate may be 500 to 5000 mL/min., in particular, 800 to 1500 mL/min., the processing pressure may be 20 to 120 g/cm², and the polishing amount may be 2.5 to 3.5 μm on each surface. In the manufacturing method according to the present invention, the disk blank is flipped in the rough polishing step. Although the timing of flipping the disk blank is not specifically limited, it is preferable to make both the surfaces of the disk blank uniformly polished, and it is more preferable to flip the disk blank when half of the entire polishing time period in the rough polishing step elapses. Preferably, polishing conditions before and after flipping are the same.

It is difficult to uniquely define other polishing conditions in the fine polishing because effects of the adopted aluminum alloy, treatment conditions and the like in step S101 to the rough polishing are exerted. However, for example, the polishing time period may be 2 to 5 minutes, the polishing surface plate rotational speed may be 10 to 35 rpm, the sun gear rotational speed may be 5 to 15 rpm, and the polishing liquid supply rate may be 500 to 5000 mL/min., in particular, 800 to 1500 mL/min., the processing pressure may be 20 to 100 g/cm², and the polishing amount may be 1.0 to 1.5 μm on each surface. In the fine polishing step, the disk blank may be flipped. In a case of flipping the disk blank, the timing of flipping the disk blank is not specifically limited. However, it is preferable to make both the surfaces of the disk blank uniformly polished, and it is more preferable to flip the disk blank when half of the entire polishing time period in the fine polishing step elapses.

As described above, before the aforementioned rough polishing step, a dummy polishing step may be performed. The condition for the dummy polishing step is as described above.

By the steps to the polishing process step (surface polishing) after the electroless Ni—P plating treatment described above, the aluminum alloy substrate for the magnetic disk is manufactured.

The magnetic material adhesion step (step 112) can be performed by an ordinary method. Preferably, the magnetic material layers are formed without performing an excessive thermal treatment such that the substrate for a magnetic disk (magnetic disk) after forming the magnetic material layers also has Wa and μWa after the thermal shock test similar to Wa and μWa of the aforementioned substrate for a magnetic disk after the thermal shock test.

### <Method for Manufacturing Glass Substrate>

Next, an example of a glass substrate for a magnetic disk, and a magnetic disk manufacturing method using the same is described.

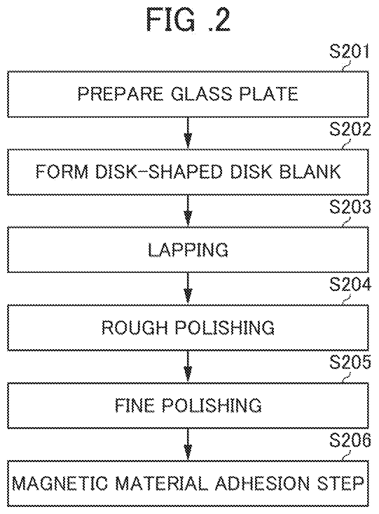

FIG. 2 is a flowchart showing an example of a glass substrate, and a magnetic disk manufacturing method using the same. As shown in FIG. 2, first, the glass plate manufacturing method prepares glass plates having a predetermined thickness (step S201). Next, by coring each prepared glass plate, and further performing an end face polishing process on the inner and outer peripheries, a disk-shaped disk blank is formed (step S202). Furthermore, as needed, a step of lapping each disk-shaped disk blank is performed (step S203). Next, a rough polishing step (step S204) of integrally clamping the formed disk blanks from the top and bottom with polishing pads, and simultaneously polishing the disk blanks with, for example, cerium oxide abrasive grains is performed, and subsequently, a fine polishing step (step S205) of further polishing the individual disk blanks polished in step S204 simultaneously with, for example, colloidal silica abrasive grains is performed, thus manufacturing glass substrates. The manufactured glass substrate is formed into a magnetic disk by a magnetic material adhesion step (step S206).

Hereinafter, referring to FIG. 2, each step is specifically described.

First, the preparation of glass plates in step S201 can be executed using a publicly known manufacturing method, such as the float method, down draw method, and direct pressing method, with molten glass being adopted as a material. It is preferable to use the redraw method of heating and softening a base glass plate manufactured using the float method or the like and of drawing the plate to desired thickness because a glass plate having a small variation in thickness can be relatively easily manufactured.

Next, in the formation of the disk-shaped disk blanks in step S202, the disk-shaped disk blanks are formed by the coring step, and the end face polishing step for the inner and outer peripheries, from the glass plates prepared in step S201. Each formed disk blank is a disk-shaped disk blank that has two main surfaces, and a circular hole formed at the center.

As needed, a lapping step in step S203 is performed, and lapping is applied to each disk-shaped disk blank formed in step S202, thereby allowing the thickness of the disk blank to be adjusted. Preferably, the lapping step is performed in a case where the thickness of each glass plate largely varies, such as a case where the redraw method is not adopted in step S201 described above. The lapping step can be performed so that the variation in thickness of each glass plate is about ±3 μm. The lapping process can be performed according to an ordinary method, for example, can be executed using a batch-type double-sided polisher that uses diamond pellets.

Next, a polishing process is performed on the principal surfaces of each disk blank obtained in step S202 or S203 described above. Preferably, the polishing process step is performed in multiple polishing stages with the diameters of the polishing abrasive grains being adjusted. The polishing process step includes at least two stages of polishing that are rough polishing (S204) and fine polishing (S205).

In the rough polishing step in step S204, the main surfaces of each disk blank are roughly polished.

The rough polishing condition is not specifically limited. However, it is preferable that hard polishing pads having a hardness of 86 to 88 are used, the polishing surface plate rotational speed is 10 to 35 rpm, the sun gear rotational speed is 5 to 15 rpm, the polishing liquid supply rate is 1000 to 5000 mL/min., in particular, 1000 mL/min. or more and less than 2000 mL/min., the processing pressure is 20 to 120 g/cm², the polishing time period is 2 to 10 minutes, and the polishing amount is 40 to 60 μm on one surface. Preferably, polishing pads made of hard polyurethane or the like are used as the polishing pads. Preferably, a polishing liquid containing polishing abrasive grains made of cerium oxide with an average particle diameter 0.1 to 1.0 μm is used as a polishing liquid.

In the manufacturing method according to the present invention, the disk blank is flipped in the rough polishing step. Although the timing of flipping the disk blank is not specifically limited, it is preferable to make both the surfaces of the disk blank uniformly polished, and it is more preferable to flip the disk blank when half of the entire polishing time period in the rough polishing step elapses. Preferably, polishing conditions before and after flipping are the same. Although the inversion of the disk blank (flipping) is only required to be performed once in the polishing treatment, the flipping may be performed twice or more. For example, in a case of performing flipping multiple times, it is preferable to perform polishing so that the sum of time periods in which each surface is oriented upward, and the sum of time periods in which the corresponding surface is oriented downward can be the same.

As described above, before the rough polishing step in step S204 described above, a dummy polishing step may be performed. The condition for the dummy polishing step is as described above.

Next, in the fine polishing step in step S205, the roughly polished main surfaces are finely polished. The fine polishing can be executed by replacing the polishing pads of the double-sided simultaneous polisher with softer polishing pads for fine polishing made of, for example, urethane foam, and by polishing each glass substrate using these polishing pads while supplying a polishing liquid containing small polishing abrasive grains made of colloidal silica with a small average particle diameter of 0.01 to 0.10 μm. As a result, the main surfaces of each disk blank can be polished to mirror surfaces, and thus a glass substrate for a magnetic disk is manufactured.

The fine polishing conditions are not specifically limited. However, it is preferable that soft polishing pads having a hardness of 75 to 77 are used, the polishing surface plate rotational speed is 10 to 35 rpm, the sun gear rotational speed is 5 to 15 rpm, the polishing liquid supply rate is 1000 to 5000 mL/min., in particular, 1000 mL/min. or more and less than 2000 mL/min., the processing pressure is 20 to 100 g/cm², the polishing time period is 2 to 12 minutes, and the polishing amount is 5 to 15 μm on one surface.

In the fine polishing step, the disk blank may be flipped. In a case of flipping the disk blank, the timing of flipping the disk blank is not specifically limited. However, it is preferable to make both the surfaces of the disk blank uniformly polished, and it is more preferable to flip the disk blank when half of the entire polishing time period in the fine polishing step elapses.

Note that in the polishing process, a chemical strengthening treatment using a sodium nitrate solution or a potassium nitrate solution may be performed.

The magnetic material adhesion step (step S206) can be performed by an ordinary method. Preferably, the magnetic material layers are formed without performing an excessive thermal treatment such that the substrate for a magnetic disk (magnetic disk) after forming the magnetic material layers has Wa and μWa after the thermal shock test similar to Wa and μWa of the substrate for a magnetic disk after the thermal shock test.

### {Magnetic Disk}

The present invention also encompasses a magnetic disk having a pair of main surfaces and having a long-wavelength waviness Wa of 2.0 nm or less with a cutoff wavelength of 0.4 to 5.0 mm and a short-wavelength waviness μWa of 0.15 nm or less with a cutoff wavelength of 0.08 to 0.45 mm, measured at 25° C. on at least one of the main surfaces after the following thermal shock test,

### <Thermal Shock Test>

the thermal shock test being performed by repeating a cycle of heating the magnetic disk at 120° C. for 30 minutes and subsequently cooling the magnetic disk at −40° C. for 30 minutes for 200 times.

The magnetic disk according to the present invention may be formed of any of publicly known substrates. The size and material are not specifically limited. However, it is preferable that the magnetic disk is based on an aluminum alloy substrate or a glass alloy substrate in order to achieve a magnetic disk having a more improved planar level. In order to make the advantageous effects of the present invention particularly significant, it is preferable to be based on a substrate having a thickness dimension of less than 0.5 mm, and an outer diameter dimension of 95 mm or more. More preferably, the disk is formed of the substrate for a magnetic disk according to the present invention. Particularly preferably, the disk is formed of the substrate for a magnetic disk made of the material obtained by the manufacturing method described above.

Even if the substrate for a magnetic disk according to the present invention is provided with a magnetic material layer on each surface, and a protective film layer and a lubricant film layer further thereon as required, the magnetic material layer and the like have a significantly smaller thickness than the substrate does. Accordingly, high long-term reliability is held with no substantial effect on the long-wavelength waviness and the short-wavelength waviness after the thermal shock test, thus achieving the object of the present application.

### EXAMPLES

Hereinafter, the present invention is described in further detail based on Examples. However, the present invention is not limited thereto.

### Example 1

A5086 alloy (aluminum alloy A) was melt according to a usual method (step S101), and was DC-cast (vertical semi-continuous casting) into a slab having a width of 1310 mm× a plate thickness of 500 mm (step S102). Four surfaces of the slab (at least including main surfaces) were each removed by 10 mm, and the slab was subjected to the homogenization treatment at 540° C. for 6 hours (step S103), and subsequently, was hot-rolled at a hot rolling start temperature of 540° C. and a hot rolling end temperature of 350° C., thus obtaining a hot-rolled plate with a plate thickness of 3.0 mm (step S104). The hot-rolled plate was cold-rolled, thus obtaining a cold-rolled plate with a plate thickness of 0.48 mm (step S105).

The cold-rolled plate was punched into a disk shape with an inner diameter of 24 mm and an outer diameter of 98 mm by a press machine, and subsequently was subjected to a pressurizing and flattening treatment of applying press-annealing at 320° C. for 3 hours using a continuous annealing furnace in the atmosphere while being pressurized with a load of 30 kgf/cm² (step S106). Thus, disk blanks were obtained. Furthermore, by applying a cutting process to the inner and outer peripheries of each disk blank, a disk-shaped disk blank with an inner diameter of 25 mm and an outer diameter of 97 mm was obtained. In this case, a chamfering process was applied to the inner and outer peripheral end faces at the same time.

The surfaces of each processed disk blank were ground using 4000s SiC grinding stones, and a batch-type double-sided simultaneous polisher (trade name: 9B double-sided grinding machine made by SPEEDFAM Inc.) into a shape with a plate thickness of 0.46 mm (step S107). The rotational speed of each of the upper and lower surface plates was 30 rpm.

Both the surfaces of the disk blank were subjected to a degreasing treatment and an etching treatment (step S108), and a first zincate treatment, a Zn peeling treatment, and a second zincate treatment (step S109), as described below.

The degreasing treatment was performed using a degreasing solution AD-68F (trade name, made by C. Uyemura & Co., Ltd.) under the condition at a temperature of 45° C. for a treatment time period of 3 minutes at a concentration of 500 mL/L.

The etching treatment was performed using AD-107F (trade name, made by C. Uyemura & Co., Ltd.) etching solution under the condition at a temperature of 60° C. for a treatment time period of 2 minutes at a concentration of 50 mL/L.

The first zincate treatment was performed using a zincate treatment solution AD-301F-3X (trade name, made by C. Uyemura & Co., Ltd.) under the condition at a temperature of 20° C. for a treatment time period of 1 minute at a concentration of 200 mL/L.

The Zn peeling treatment was performed using a commercially available nitric acid reagent under the condition at a temperature of 25° C. for a treatment time period of 60 seconds at a nitric acid concentration of 30%.

The second zincate treatment was performed under the condition similar to that of the first zincate treatment.

Pure water cleaning was executed between each treatment from the degreasing treatment to the second zincate treatment.

Subsequently, an electroless Ni—P plating treatment was performed to both the surfaces of each disk blank obtained in step S109 using NIMUDEN HDX (trade name, made by C. Uyemura & Co., Ltd.) plating solution under the condition at a temperature of 88° C. for a treatment time period 130 minutes at a Ni concentration of 6 g/L (step S110).

Furthermore, the Ni—P-plated disk blank was set in the double-sided simultaneous polisher (trade name: 9B double-sided grinding machine made by SPEEDFAM Inc.), and was subjected to the dummy polishing step, the rough polishing step, and the fine polishing step (step S111), thus manufacturing an aluminum alloy substrate. Hereinafter, description is made in detail.

First, dummy polishing was performed, before the rough polishing treatment. For the dummy polishing, one of the fabricated electroless-Ni—P-plated substrates (before the rough polishing) was adopted as a dummy substrate, and hard urethane polishing pads with a hardness of 87 (trade name: FF-5, made by Fujibo Ehime Co., Ltd.) were used as polishing pads. The dummy polishing was performed multiple times under the condition of the rough polishing step described later. At the sixth time, the long-wavelength waviness Wa of the dummy substrate after polishing measured with a cutoff wavelength of 0.4 to 5.0 mm became less than 2.5 nm (2.19 nm). Accordingly, the dummy polishing was finished.

Note that in the rough polishing in Examples 2 and 3, and Comparative Examples 1 and 2 described later, the polishing pads with the surface state having been adjusted through the dummy polishing in Example 1 were used. Accordingly, no dummy polishing was performed before the rough polishing.

The Ni—P-plated main surfaces of the Ni—P-plated disk blank were roughly polished with the hard urethane polishing pads having a hardness 87 obtained through the dummy polishing step described above, and a polishing liquid containing abrasive grains made of alumina with an average particle diameter of 0.4 μm. In the rough polishing (at a time point when half of the polishing time period elapsed), the disk blank was flipped. Note that other polishing conditions in the rough polishing step include a polishing time period of 5 minutes, a polishing surface plate rotational speed of 30 rpm, a sun gear rotational speed of 10 rpm, a polishing liquid supply rate of 1000 mL/min., a processing pressure of 100 g/cm², and a polishing amount of 3.0 μm on one surface.

The Ni—P-plated disk blank after the rough polishing was cleaned with pure water, was finely polished with soft urethane polishing pads with a hardness of 76 (trade name: FK1-N, made by Fujibo Ehime Co., Ltd.), and a polishing liquid containing colloidal silica abrasive grains with an average particle diameter of 0.08 μm, and was formed into an aluminum alloy substrate with a plate thickness of 0.48 mm as a substrate for a magnetic disk. Note that other polishing conditions in the fine polishing step include a polishing time period of 5 minutes, a polishing surface plate rotational speed of 30 rpm, a sun gear rotational speed of 10 rpm, a polishing liquid supply rate of 1000 mL/min., a processing pressure of 60 g/cm², and a polishing amount of 1.3 μm on one surface.

### Example 2

An Al—Fe—Mn—Ni alloy (aluminum alloy B) was melted according to a usual method, and was DC-cast (vertical semi-continuous casting) into a slab having a width of 1310 mm× a plate thickness of 500 mm. The slab was removed by 10 mm on each surface, a homogenization treatment at 520° C. for 6 hours was applied, was subjected to hot rolling with a hot rolling start temperature of 520° C. and a hot rolling end temperature of 330° C., thus forming a hot-rolled plate with a plate thickness of 3.0 mm. The hot-rolled plate was cold-rolled, thus obtaining a cold-rolled plate with a plate thickness of 0.48 mm. Except that the cold-rolled plate was used instead of the cold-rolled plate in Example 1, an aluminum alloy substrate with a plate thickness of 0.48 mm was formed in a manner similar to that described in Example 1.

The composition of the aluminum alloy B contains Fe: 0.7% by mass, Mn: 0.9% by mass, and Ni: 1.7% by mass, and the remaining parts containing aluminum and unavoidable impurities.

### Example 3

An Al—Fe—Mn—Mg—Ni alloy (aluminum alloy C) was melted according to a usual method, and was DC-cast (vertical semi-continuous casting) into a slab having a width of 1310 mm× a plate thickness of 500 mm. The slab was removed by 10 mm on each of four surfaces, a homogenization treatment at 520° C. for 6 hours was applied, was subjected to hot rolling with a hot rolling start temperature of 520° C. and a hot rolling end temperature of 330° C., thus forming a hot-rolled plate with a plate thickness of 3.0 mm. The hot-rolled plate was cold-rolled, thus obtaining a cold-rolled plate with a plate thickness of 0.48 mm. Except that the cold-rolled plate was used instead of the cold-rolled plate in Example 1, an aluminum alloy substrate with a plate thickness of 0.48 mm was formed in a manner similar to that described in Example 1.

The composition of the aluminum alloy C contains Fe: 0.7% by mass, Mn: 0.3% by mass, Mg: 1.4% by mass, and Ni: 1.8% by mass, and the remaining parts containing aluminum and unavoidable impurities.

### Example 4

Using the redraw method, glass plates made of aluminosilicate glass (SiO₂: 65% by mass, Al₂O₃: 18% by mass, B₂O₃: 4% by mass, Li₂O: 4% by mass, Na₂O: 1% by mass, CaO: 4% by mass, P₂O₅: 1% by mass, and other trace components) with a width of 100 mm and a length of 10 m was manufactured, and a glass plate with a thickness of 0.60 mm was selected (step S201). The selected glass plate was subjected to coring, and end face polishing on the inner and outer peripheries, and a disk-shaped disk blank with an outer diameter of 97 mm and a circular hole inner diameter of 25 mm was formed (step S202). Furthermore, the formed disk-shaped disk blank was set in the double-sided simultaneous polisher, and subjected to the rough polishing step (step S204) and the fine polishing step (step S205), thus manufacturing a glass substrate. Note that the polishing pads were adjusted in a suitable state. Accordingly, no dummy polishing was performed.

In the rough polishing step, hard urethane polishing pads with a hardness of 87 (trade name: FF-5, made by Fujibo Ehime Co., Ltd.), and a polishing liquid that contains loose grains obtained by applying pure water to cerium oxide polishing abrasive grains with an average particle diameter of 0.19 μm were used. By flipping the disk blank 5 minutes after start of the rough polishing, the front and back were replaced with each other, and rough polishing was further performed for 5 minutes. Other polishing conditions in the rough polishing step include a polishing surface plate rotational speed of 25 rpm, a sun gear rotational speed of 10 rpm, a polishing liquid supply rate of 1500 mL/min., a processing pressure of 120 g/cm², and a polishing amount of 50 μm on one surface. Thus, a glass substrate with a plate thickness of 0.50 mm was obtained.

On the other hand, in the fine polishing step, soft urethane polishing pads with a hardness of 76 (trade name: FK1-N, made by Fujibo Ehime Co., Ltd.), and a polishing liquid that contains loose grains obtained by applying pure water to colloidal silica with an average particle diameter of 0.08 μm were used. Other polishing conditions in the fine polishing step include a polishing surface plate rotational speed of 25 rpm, a sun gear rotational speed of 10 rpm, a polishing liquid supply rate of 1500 mL/min., a polishing time period of 8.5 minutes, a processing pressure of 50 to 120 g/cm², and a polishing amount of 10 μm on one surface. Thus, a glass substrate with a plate thickness of 0.48 mm was obtained.

### Comparative Example 1

An aluminum alloy substrate was obtained in a manner similar to that in Example 1 except that the press-annealing condition was changed to 2000 for 3 hours while applying a pressure of a load of 30 kgf/cm² in the atmosphere, and the disk blank was not flipped in the rough polishing step.

### Comparative Example 2

An Al—Fe—Mn—Ni alloy (aluminum alloy B) was melted according to a usual method, and was CC-cast (continuous casting) into what had a width of 1420 mm× a plate thickness of 6.0 mm. The continuous-cast coil was cold-rolled into what had a plate thickness of 0.48 mm. Except that the cold-rolled plate was used instead of the cold-rolled plate in Example 1, and the disk blank was not flipped in the rough polishing step, an aluminum alloy substrate with a plate thickness of 0.48 mm was formed in a manner similar to that described in Example 1.

### Comparative Example 3

The glass substrate was created in a manner similar to that in Example 4 except that in the rough polishing step, hard urethane polishing pads with a hardness of 87, and a polishing liquid containing loose grains obtained by applying pure water to cerium oxide with an average particle diameter of 1.50 μm were used, and the disk blank was not flipped in the rough polishing.

The aluminum alloy substrates in Examples 1 to 3 and Comparative Examples 1 and 2, and the glass substrates in Example 4 and Comparative example 3 obtained as described above were subjected to a thermal shock test, and subsequently, the long-wavelength waviness Wa and the short-wavelength waviness μWa of each of these substrates were measured. Description is made in detail.

### (Thermal Shock Test)

The thermal shock test was performed by repeating a cycle of heating the aluminum alloy substrates and the glass substrates at 120° C. for 30 minutes, and subsequently cooling the substrates at −40° C. for 30 minutes 200 times, using a bench-top type environmental test chamber SH-261 (trade name, made by ESPEC CORP.).

### (Long-Wavelength Waviness Measurement)

The long-wavelength waviness Wa with a cutoff wavelength of 0.4 to 5.0 mm:

The long-wavelength waviness Wa of a main surface of the aluminum alloy substrate or the glass substrate after the thermal shock test with a cutoff wavelength of 0.4 to 5.0 μm was measured using a surface shape measurement device OptiFlat (trade name, made by Phaseshift Technologies Inc.) was used. The measurement range was the entire main surface (one surface) of the aluminum alloy substrate or the glass substrate after the thermal shock test, and the measurement temperature was 25° C. The measurement was performed for three each of the aluminum alloy substrates and the glass substrates after the thermal shock test (n=3). A mean value of measurements on three substrates was adopted as a long-wavelength waviness Wa.

### (Short-Wavelength Waviness Measurement)

The short-wavelength waviness μWa with a cutoff wavelength of 0.08 to 0.45 mm:

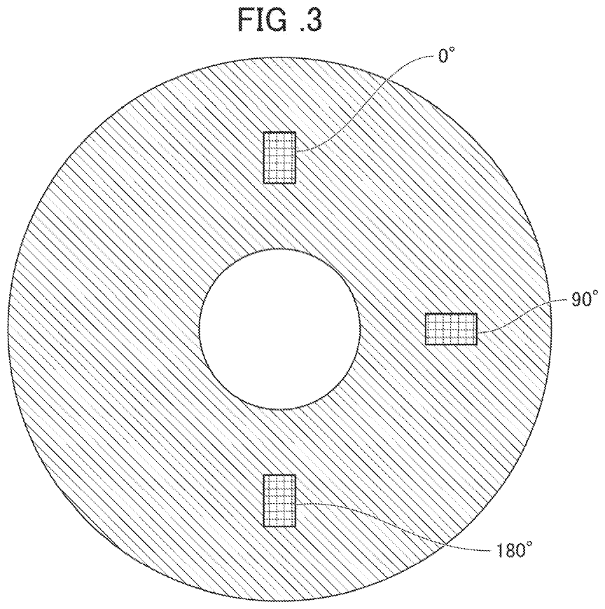

A short-wavelength waviness μWa with a cutoff wavelength of 0.08 to 0.45 mm in each rectangular area of 9.9 mm×3.5 mm at the center in the radial direction (arranged so that a virtual center line at the center in the direction of the long side of 9.9 mm is parallel to the radial direction) on the main surface (one surface) of the aluminum alloy substrate or the glass substrate after the thermal shock test, using a particle size distribution analyzer microZAM-1200 (trade name, made by Phaseshift Technologies Inc.). The measurement temperature was 25° C. The measurements were performed using three each of the aluminum alloy substrates and the glass substrates after the thermal shock test, at three locations each positioned at 0°, 90°, and 180° in the circumferential direction at the centers in radial directions as shown in FIG. 3 respectively. A mean value of thus obtained nine measurements was adopted as the short-wavelength waviness μWa.

Table 1 shows the obtained result. An “Evaluation” field in Table 1 shows good (indicated by circle symbol (o)) if the long-wavelength waviness Wa was 2.0 nm or less, and the short-wavelength waviness μWa was 0.15 nm or less, and shows poor (indicated by cross symbol (x)) if at least one of the long-wavelength waviness Wa and the short-wavelength waviness μWa was out of the range.

Note that neither OptiFlat nor microZAM-1200 can measure the long-wavelength waviness and the short-wavelength waviness of transparent glass because of the measurement principle. Accordingly, aluminum was deposited on a measurement surface of a glass substrate after the thermal shock test, and the substrate was made optically opaque, and was subsequently measured. Since the deposited layer is significantly thin and smooth, the layer does not affect the measurement of the long-wavelength waviness and the short-wavelength waviness.

Table 1 shows evaluation results. The substrates for each magnetic disk in Examples 1 to 4 had a long-wavelength waviness Wa of 2.0 nm or less with a cutoff wavelength of 0.4 to 5.0 mm and a short-wavelength waviness μWa of 0.15 nm or less with a cutoff wavelength of 0.08 to 0.45 mm, measured at 25° C. after the thermal shock test.

On the other hand, any of the substrate for each magnetic disk in Comparative Examples 1 to 3 did not satisfy the aforementioned Wa and μWa. In Comparative Examples 1 to 3, the disk blank was not flipped in the rough polishing step (furthermore, in Comparative example 3, the average particle diameter of polishing abrasive grains in the rough polishing step was large). As a result, distortions non-uniformly remained in the material. Accordingly, it is conceivable that Wa and μWa could not be adjusted even by the manufacturing method according to the present invention.

TABLE 1

| | | Long- | Short- | |
|---|---|---|---|---|
| | | wavelength | wavelength | |
| | | waviness Wa | waviness | |
| | | (mm) | μWa (mm) | |
| Example/ | | Cutoff | Cutoff | |
| Comparative | | wavelength | wavelength | Evalua- |
| Example | Sample | 0.4-5.0 mm | 0.08-0.45 mm | tion |
| Example 1 | Aluminum alloy | 1.14 | 0.11 | ◯ |
| | A | | | |
| Example 2 | Aluminum alloy | 1.57 | 0.10 | ◯ |
| | B | | | |
| Example 3 | Aluminum alloy | 0.84 | 0.11 | ◯ |
| | C | | | |
| Example 4 | Aluminosilicate | 0.64 | 0.08 | ◯ |
| | glass | | | |
| Comparative | Aluminum alloy | 3.40 | 0.62 | X |
| Example 1 | A | | | |
| Comparative | Aluminum alloy | 2.53 | 0.20 | X |
| Example 2 | B | | | |
| Comparative | Aluminosilicate | 6.40 | 0.43 | X |
| Example 3 | glass | | | |

### EXPLANATION OF REFERENCE NUMERALS

S101 Prepare aluminum alloy
S102 Cast aluminum alloy
S103 Homogenization treatment
S104 Hot rolling
S105 Cold rolling
S106 Heating and flattening treatment
S107 Cutting and grinding process
S108 Degreasing and etching treatment
S109 Zincate treatment
S110 Ni—P plating treatment
S111 Polishing process step
S112 Magnetic material adhesion step
S201 Prepare glass plate
S202 Form disk-shaped disk blank
S203 Lapping
S204 Rough polishing
S205 Fine polishing
S206 Magnetic material adhesion step

1. A substrate for a magnetic disk having a pair of main surfaces and having a long-wavelength waviness Wa of 2.0 nm or less with a cutoff wavelength of 0.4 to 5.0 mm and a short-wavelength waviness μWa of 0.15 nm or less with a cutoff wavelength of 0.08 to 0.45 mm, measured at 25° C. on at least one of the main surfaces after a following thermal shock test,
<thermal shock test>
the thermal shock test being performed by repeating a cycle of heating the substrate for a magnetic disk at 120° C. for 30 minutes and subsequently cooling the substrate for a magnetic disk at −40° C. for 30 minutes for 200 times.

2. The substrate for a magnetic disk according to claim 1, having the long-wavelength waviness Wa of 0.5 nm or more, and the short-wavelength waviness μWa of 0.05 nm or more.

3. The substrate for a magnetic disk according to claim 1, wherein the substrate for a magnetic disk has a plate thickness of less than 0.50 mm.

4. The substrate for a magnetic disk according to claim 1, wherein the substrate for a magnetic disk is a disk body having an outer diameter of 95 mm or more.

5. The substrate for a magnetic disk according to claim 1, wherein the substrate for a magnetic disk is for heat-assisted magnetic recording (HAMR) or microwave assisted magnetic recording (MAMR).

6. A magnetic disk having a pair of main surfaces and having a long-wavelength waviness Wa of 2.0 nm or less with a cutoff wavelength of 0.4 to 5.0 mm and a short-wavelength waviness μWa of 0.15 nm or less with a cutoff wavelength of 0.08 to 0.45 mm, measured at 25° C. on at least one of the main surfaces after a following thermal shock test,
<thermal shock test>
the thermal shock test being performed by repeating a cycle of heating the magnetic disk at 120° C. for 30 minutes and subsequently cooling the magnetic disk at −40° C. for 30 minutes for 200 times.

7. A manufacturing method of the substrate for a magnetic disk according to claim 1, wherein the substrate for a magnetic disk is obtained from a disk blank, the method comprising:
a rough polishing step of simultaneously roughly polishing both the main surfaces of the disk blank; and a fine polishing step of finely polishing both the main surfaces of the disk blank subjected to the rough polishing,
wherein the rough polishing step further includes flipping front and back surfaces of the disk blank in the rough polishing step.

8. The manufacturing method according to claim 7 for manufacturing the substrate for a magnetic disk, further comprising a dummy polishing step as a previous step to the rough polishing step, wherein the dummy polishing step is performed using two polishing pads to be used in the rough polishing step and a dummy substrate manufactured under the same conditions as those for the disk blank to adjust a surface state of the polishing pads, and the dummy substrate is polished using the two polishing pads under the conditions similar to the conditions for the rough polishing step until the dummy substrate comes to have a long-wavelength waviness Wa of less than 2.5 nm with a cutoff wavelength of 0.4 to 5.0 mm on one surface, and
the disk blank is polished in the rough polishing step using the polishing pads with the surface state being adjusted.

9. The substrate for a magnetic disk according to claim 2, wherein the substrate for a magnetic disk has a plate thickness of less than 0.50 mm.

10. The substrate for a magnetic disk according to claim 2, wherein the substrate for a magnetic disk is a disk body having an outer diameter of 95 mm or more.

11. The substrate for a magnetic disk according to claim 3, wherein the substrate for a magnetic disk is a disk body having an outer diameter of 95 mm or more.

12. The substrate for a magnetic disk according to claim 9, wherein the substrate for a magnetic disk is a disk body having an outer diameter of 95 mm or more.

13. The substrate for a magnetic disk according to claim 2, wherein the substrate for a magnetic disk is for heat-assisted magnetic recording (HAMR) or microwave assisted magnetic recording (MAMR).

14. The substrate for a magnetic disk according to claim 3, wherein the substrate for a magnetic disk is for heat-assisted magnetic recording (HAMR) or microwave assisted magnetic recording (MAMR).

15. The substrate for a magnetic disk according to claim 4, wherein the substrate for a magnetic disk is for heat-assisted magnetic recording (HAMR) or microwave assisted magnetic recording (MAMR).

16. The substrate for a magnetic disk according to claim 9, wherein the substrate for a magnetic disk is for heat-assisted magnetic recording (HAMR) or microwave assisted magnetic recording (MAMR).

17. The substrate for a magnetic disk according to claim 10, wherein the substrate for a magnetic disk is for heat-assisted magnetic recording (HAMR) or microwave assisted magnetic recording (MAMR).

18. The substrate for a magnetic disk according to claim 11, wherein the substrate for a magnetic disk is for heat-assisted magnetic recording (HAMR) or microwave assisted magnetic recording (MAMR).

19. A manufacturing method of the substrate for a magnetic disk according to claim 2, wherein the substrate for a magnetic disk is obtained from a disk blank, the method comprising:
a rough polishing step of simultaneously roughly polishing both the main surfaces of the disk blank; and a fine polishing step of finely polishing both the main surfaces of the disk blank subjected to the rough polishing,
wherein the rough polishing step further includes flipping front and back surfaces of the disk blank in the rough polishing step.

20. The manufacturing method according to claim 19 for manufacturing the substrate for a magnetic disk, further comprising a dummy polishing step as a previous step to the rough polishing step, wherein the dummy polishing step is performed using two polishing pads to be used in the rough polishing step and a dummy substrate manufactured under the same conditions as those for the disk blank to adjust a surface state of the polishing pads, and the dummy substrate is polished using the two polishing pads under the conditions similar to the conditions for the rough polishing step until the dummy substrate comes to have a long-wavelength waviness Wa of less than 2.5 nm with a cutoff wavelength of 0.4 to 5.0 mm on one surface, and
the disk blank is polished in the rough polishing step using the polishing pads with the surface state being adjusted.
